(19) United States
(12) Patent Application Publication
(10) Pub. No.: US 2014/0348690 A1
(43) Pub. Date: Nov. 27, 2014

(54) Method for flexibly sintering rare earth permanent magnetic alloy and sintering equipment thereof

(71) Applicant: SHENYANG GENERAL MAGNETIC CO., LTD., Shenyang, Liaoning (CN)

(72) Inventors: Xiaodong Chen, Shenyang (CN); Baoyu Sun, Shenyang (CN)

(21) Appl. No.: 14/367,897

(22) PCT Filed: Feb. 5, 2013
(86) PCT No.: PCT/CN2013/071356

§ 371 Date: Jun. 21, 2014

(30) Foreign Application Priority Data
Nov. 8, 2012 (CN) 201210443986.0
Nov. 8, 2012 (CN) 201210445605.2

(51) Int. Cl. H01F 41/02

(52) U.S. Cl. CPC H01F 41/0266; B22F 2201/10; B22F 2201/20; B22F 2998/10
USPC 419/38; 425/78

(57) ABSTRACT

A method for flexibly sintering rare earth permanent magnetic alloy comprises: (1) weighing fine powder of rare earth permanent magnetic alloy, loading the fine powder in moulds, and orientedly compacting the fine powder in a press machine and in inert atmosphere to obtain blanks and loading the blanks into charging boxes; (2) opening the two isolating valves connected with each other; wherein after a first rolling wheel transmission in the second conveying vehicle transfers the charging tray into the first chamber of the glove box, the two isolating valves are closed, and the second conveying vehicle leaves; (3) locking two matching flanges of the two isolating valves tightly; (4) locking matching flanges tightly; and (5) processing the blanks with heating and heat preservation according to a preset process curve; wherein the blanks are sintered at a highest temperature of 1200° C.

### CROSS REFERENCE OF RELATED APPLICATION

This is a U.S. National Stage under 35 U.S.C. 371 of the International Application PCT/CN2013/071356, filed Feb. 5, 2013, which claims priority under 35 U.S.C. 119(a-d) to CN 201210445605.2, filed Nov. 8, 2012, and CN201210443986.0, filed Nov. 8, 2012.

### BACKGROUND OF THE PRESENT INVENTION

1. Field of Invention

The present invention relates to a field of processing rare earth permanent magnetic alloy, and more particularly to a method for flexibly sintering neodymium-iron-boron rare earth permanent magnetic alloy and a sintering equipment therefor.

2. Description of Related Arts

The neodymium-iron-boron rare earth permanent magnet is widely applied in electronic equipments, motors, hybrid vehicles, etc., and the application of the neodymium-iron-boron rare earth permanent magnet also becomes wider and wider.

Referring to the Chinese patent CN 01248403.2, a conventional equipment for sintering neodymium-iron-boron rare earth permanent magnetic alloy comprises: a furnace body; a heating chamber provided in the furnace body; and a nozzle provided on a wall of the heating chamber; wherein a valve is provided at a side of the furnace body, the furnace body is connected with a sealed glove box with a vacuum line via a valve, in such a manner that the problems of product oxidization, poor cooling uniformity, and poor consistency are effectively solved.

The conventional equipment has problems of great investment, large area occupation, low automaticity, which is not able to realize non-oxidation during the whole process of sintering the neodymium-iron-boron rare earth permanent magnetic alloy.

### SUMMARY OF THE PRESENT INVENTION

In order to solve above technical problems, the present invention provides a method for flexibly sintering rare earth permanent magnetic alloy and a sintering equipment therefor.

Technical solutions of the present invention are as follows.

Specific procedures are as follows.

(1) Fine powder of rare earth permanent magnetic alloy is weighed, loaded in moulds, and orientedly compacted in a press machine and in inert atmosphere to obtain blanks After the blanks compacted are loaded in charging boxes, the charging boxes are piled upon a charging tray. After a second conveying vehicle is coupled with the press machine, matching flanges of two isolating valves are locked tightly. After air between the two isolating valves is replaced with inert gas, the two isolating valves are opened. After a fork of the second conveying vehicle transfers the charging tray in the press machine into the second conveying vehicle, the two isolating valves are closed. The second conveying vehicle leaves and then is coupled with a first isolating valve of a first chamber in a glove box.

(2) After air between the second conveying vehicle and the first isolating valve of the glove box is replaced with inert gas, the two isolating valves connected with each other are opened. After a first rolling wheel transmission in the second conveying vehicle transfers the charging tray into the first chamber of the glove box, the two isolating valves are closed, and the second conveying vehicle leaves. After a second isolating valve of the glove box is opened, material in the first chamber is transferred to a second chamber by rolling wheel transmissions, and then the second isolating valve is closed. The blanks are loaded into graphite charging boxes manually in the second chamber, and the graphite charging boxes are piled upon the charging tray.

(3) After a first conveying vehicle is coupled with a third isolating valve at an end of the second chamber, two matching flanges of the two isolating valves are locked tightly. After air between the two isolating valves is replaced with inert gas, the two isolating valves connected with each other are opened. Rolling wheel transmissions in the second chamber and the first conveying vehicle are started to transfer the charging tray in the second chamber to the first conveying vehicle. Then the two isolating valves are closed, and the first conveying vehicle leaves.

(4) After the first conveying vehicle is coupled with an isolating valve of a sintering furnace, matching flanges are locked tightly. After air between the two isolating valves is replaced with inert gas, a balance valve is opened to equalize pressures in the sintering furnace and the first conveying vehicle. After the pressures are equal, the two isolating valves connected with each other are opened. A fork mechanism in the first conveying vehicle which is horizontally driven by a screw rod and vertically driven by a cylinder is started to transfer the charging tray into the sintering furnace. Then the two isolating valves are closed, and the first conveying vehicle leaves.

(5) After the sintering furnace is evacuated to a vacuum degree more than 50 Pa, or the sintering furnace is filled with protective gas, the blanks are processed with heating and heat preservation according to a preset process curve. The blanks are sintered at a highest temperature of 1200° C. The sintering furnace is filled with nitrogen or argon to a pressure of 0.01˜0.03 MPa. A fan is started to cool the charging boxes and the blanks of the rare earth permanent magnetic alloy therein, until the temperature is lower than 80° C., and then the fan is stopped after at least 5 minutes. After the pressure in a furnace chamber is equal to atmosphere, the fourth isolating valve of the sintering furnace is opened. A fork of a discharging vehicle takes out the charging tray, the fourth isolating valve is closed, and then the discharging vehicle leaves.

A sintering equipment for flexibly sintering rare earth permanent magnetic alloy in the present invention comprises: a glove box, two conveying vehicles with sealed compartments, a press machine, a sintering furnace and a discharging vehicle; wherein two logistics channels are respectively provided at two ends of the glove box; the press machine and the sintering furnace are aligned at one side of the two logistics channels; the two conveying vehicles are able to move respectively in the two logistics channels; each of the two conveying vehicles, the sintering furnace and the press machine comprises an isolating valve provided at a corresponding end thereof; the glove box comprises two isolating valve respectively provided at the two ends thereof; and the two conveying vehicles are respectively coupled with the glove box, the press machine and the sintering furnace via the isolating valves.

Further, the glove box is a sealed box comprising two sealed chambers which are vacuum or filled with protective atmosphere. The two sealed chambers in the glove box are a first chamber and a second chamber. A second isolating valve is provided between the two sealed chambers. A first isolating valve and a third isolating valve are provided at two ends of the two sealed chamber. Each of the chambers comprises an evacuating pipeline, an inert gas inlet, an exhaust valve pipeline, a pressure gage and a vacuum gauge. A balance valve pipeline is provided between the two chambers for equalizing pressures of the two sealed chambers. A second rolling wheel transmission and a third rolling wheel transmission for a charging tray to place on are respectively provided in the two chambers, wherein the second chamber comprises a glove flange component.

Further, the conveying vehicle comprises an fifth isolating valve provided at a first end thereof, and a compartment door provided at a second end thereof. When the conveying vehicles are respectively coupled with the glove box, the sintering furnace or the press machine, two connecting flanges of the two isolating valves are connected tightly to form a seal joint.

Further, the first rolling wheel transmission for transferring material to the glove box and a fork mechanism for transferring the material to the sintering furnace are provided in the conveying vehicle. Universal wheels are provided at a bottom of the conveying vehicle. A first evacuating pipeline, an inert gas inlet and a first exhaust valve pipeline are provided on the conveying vehicle and connected with the conveying vehicle.

Further, the fork mechanism comprises a fork, a guiding track framework of rolling wheels, a screw driving component, a first speed reducer of motor and a first cylinder; wherein an output shaft of the first speed reducer of motor is connected with a first end of a screw of the screw driving component; a second end of the screw driving component is connected with the guiding track framework of rolling wheels which is supported by the first cylinder. The first rolling wheel transmission is installed on a compartment bottom via a supporter.

Further, the first cylinder is fixed under the compartment. A cylinder rod of the first cylinder extends into the compartment and is connected with a connecting rod of a rolling wheel axle in the guiding track framework of rolling wheels, and a rolling wheel moves in a track of a first rolling wheel track component.

Further, at least one sintering furnace is provided. The sintering furnace comprises: a fourth isolating valve provided at a first end thereof, which is also at one side of the logistics channel; and a furnace door provided at a second end thereof, which is locked with a high-pressure furnace ring for locking A furnace chamber of the sintering furnace comprises a heating chamber provided therein, and a thermal insulating layer is provided in the heating chamber. A plurality of groups of heaters and thermocouples are provided in the thermal insulating layer. The heaters are connected with a heating power cabinet via a electrode provided on the heating chamber and a copper bar provided outside the heating chamber. A plurality of nozzles which are interconnected go through the thermal insulating layer in a radial direction of the furnace chamber. An outer wall of a furnace shell has a structure of double-layer water-cooling jacket, and water-cooling inlet and outlet pipelines are provided on the outer wall of the furnace shell. An inert gas inlet, a safety valve pipeline, an exhaust valve pipeline and a air cooling system are connected with the furnace chamber. The charging tray is placed on a charging shelf of the heating chamber in the sintering furnace by the fork in the first conveying vehicle.

Further, a balance valve pipeline is provided between the furnace chamber of the sintering furnace and the fourth isolating valve for equalizing pressures.

Further, the air cooling system having an outer circulation system or an inner circulation system comprises a fan, a heat exchanger, and a plurality of nozzles provided along the furnace chamber. An air duct which is connected with the nozzles has a first end connected with the fan, and a second end connected with the heat exchanger.

Preferably, a plurality of sintering furnaces are provided, the sintering furnaces are provided side by side in front of the logistics channel.

The merits and beneficial effects are as follows.

The present invention adopts a parallel-type flexible production method. Sintering period of the neodymium-iron-boron rare earth permanent magnetic alloy is long, i.e. 24 hours. However, it only takes more than 1 hour to take the blanks of the neodymium-iron-boron rare earth permanent magnetic alloy out of the press machine, load the blanks into the graphite charging boxes manually in the glove box, and then pile the graphite charging boxes upon the charging tray. Therefore, a sealed glove box of a one-chamber sintering furnace in a conventional method is removed. Instead, a glove box is provided to operate with a plurality of one-chamber sintering furnaces with isolating valves. The conveying vehicles are coupled with the sintering furnace in the protective atmosphere.

The present invention adopts a flexible production method, wherein the conveying vehicle is coupled with the press machine in the protective atmosphere, in such a manner that non-oxidation connection from compaction to sintering is realized, and magnet performance and automaticity of production are significantly improved.

These and other objectives, features, and advantages of the present invention will become apparent from the following detailed description, the accompanying drawings, and the appended claims.

### BRIEF DESCRIPTION OF THE DRAWINGS

FIG. 1 is a sketch view of an equipment for flexibly sintering rare earth permanent magnetic alloy according to a preferred embodiment of the present invention.

FIG. 2 is a sketch view of a structure of a conveying vehicle having a sealed compartment shown in FIG. 1.

FIG. 3 is a sketch view of a structure of a glove box shown in FIG. 1.

FIG. 4 is a sketch view of a structure of a sintering furnace shown in FIG. 1.

FIG. 5 is a top view of FIG. 4.

FIG. 6 is a sketch view of a structure of an isolating valve shown in FIG. 1.

1, glove box; 2, first conveying vehicle with sealed compartment; 3, sintering furnace; 4, discharging vehicle; 5, press machine; 6, second conveying with sealed compartment; 7, compartment door; 8, first exhaust valve pipeline; 9, first observation window; 10, first electrical control cabinet; 11, second observation window; 12, first evacuating pipeline; 13, first pressure gage; 14, fifth isolating valve; 15, charging box; 16, first rolling wheel transmission; 17, fork; 18, first speed reducer of motor; 19, universal wheel; 20, guiding track framework of rolling wheels; 21, screw; 22, compartment bottom; 23, rolling wheel; 24, guiding track; 25, valve bottom; 26, flange; 27, first cylinder; 28, first rolling wheel track component; 29, screw driving component; 30, fourth evacuating pipeline; 31, first isolating valve; 32, first chamber; 33, second exhaust valve pipeline; 34, second evacuating pipeline; 35, second pressure gage; 36, second isolating valve; 37, glove flange component; 38, second chamber; 39, second electrical control cabinet; 40, third exhaust valve pipeline; 41, third evacuating pipeline; 42, third pressure gage; 43, third isolating valve; 44, charging tray; 45, third rolling wheel transmission; 46, second rolling wheel transmission; 47, third electrical control cabinet; 48, heating power cabinet; 49, copper bar; 50, fan; 51, heat exchanger; 52, furnace ring for locking; 53, furnace door; 54, electrode; 55, thermocouple; 56, fourth isolating valve; 57, water-cooling inlet and outlet pipeline; 58, heater; 59, thermal insulating layer; 60, nozzle; 61, high vacuum flapper valve; 62, rotary piston pump or rotary vane pump; 63, roots pump; 64, diffusion pump; 65, cold trap; 66, pressure gage of electric contact; 67, safety valve pipeline; 68, exhaust valve pipeline; 69, balance valve pipeline; 70, second cylinder; 71, magnetic switch; 72, axle of water inlet and outlet; 73, connecting element; 74, rubber ring; 75, water-cooling valve board; 76, hinge plate; 77, second rolling wheel track component; 78, connecting rod; 79, block; 80, upper flange; 81, supporter.

### DETAILED DESCRIPTION OF THE PREFERRED EMBODIMENT

According to the drawings and embodiments, the present invention is further described as follows.

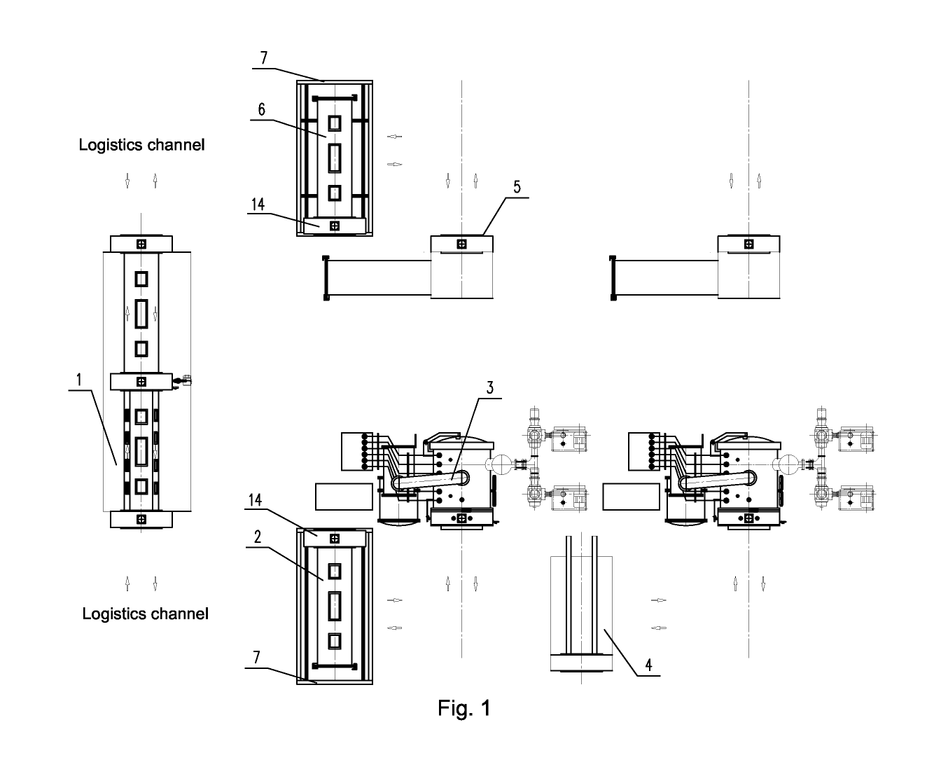

Referring to FIG. 1, a sintering equipment for flexibly sintering rare earth permanent magnetic alloy in the present invention comprises: a glove box 1, a first conveying vehicle with a sealed compartment 2, a second conveying vehicle with a sealed compartment 6, a press machine 5, a sintering furnace 3 and a discharging vehicle 4; wherein two logistics channels are respectively provided at two ends of the glove box 1; the press machine 5 and the sintering furnace 3 are aligned at one side of the two logistics channels; the first conveying vehicle 2 and the second conveying vehicle 6 are able to move respectively in the two logistics channels; each of the first conveying vehicle 2, the second conveying vehicle 6, the sintering furnace 3 and the press machine 5 comprises an isolating valve provided at a corresponding end thereof; the glove box 1 comprises two isolating valve respectively provided at the two ends thereof; and the first conveying vehicle 2 and the second conveying vehicle 6 are respectively coupled with the glove box 1, the press machine 5 and the sintering furnace 3 via the isolating valves. Preferably, a plurality of sintering furnaces 3 and a plurality of the press machines 5 could be provided side by side.

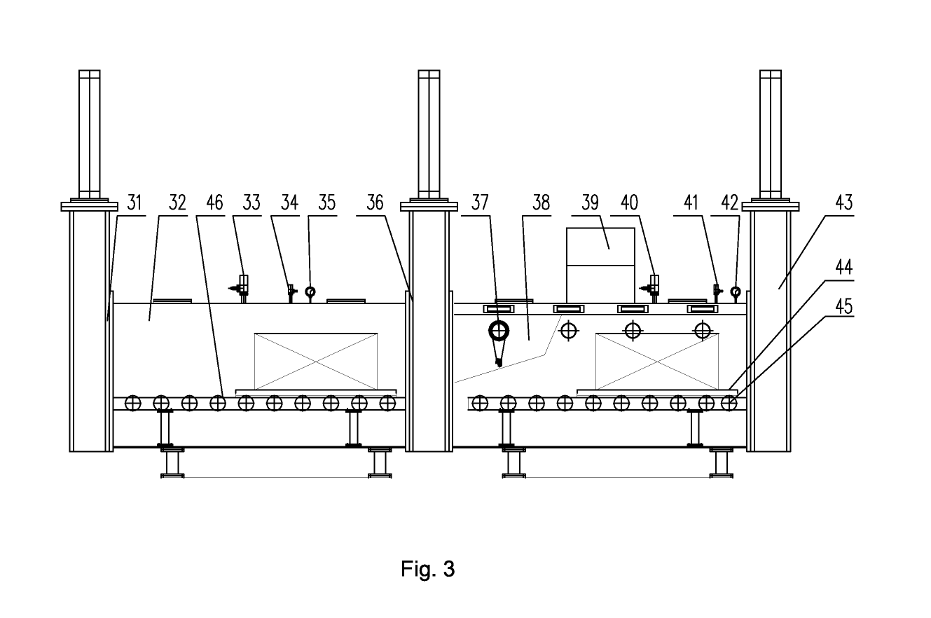

Referring to FIG. 3, the glove box 1 is a sealed box comprising two sealed chambers which are vacuum or filled with protective atmosphere. The two sealed chambers in the glove box 1 are a first chamber 32 and a second chamber 38. A second isolating valve 36 is provided between the two sealed chambers. A first isolating valve 31 is provided at a first end of the first chamber 32, and a third isolating valve 43 is provided at a second end of the second chamber 38. Each of the chambers comprises an evacuating pipeline, an inert gas inlet, an exhaust valve pipeline, a pressure gage and a vacuum gauge. A balance valve pipeline is provided between the two chambers for equalizing pressures of the two chambers. A second rolling wheel transmission 46 and a third rolling wheel transmission 45 for a charging tray 44 to place on are respectively provided in the two chambers, wherein the second chamber 38 comprises a glove flange component t37 and a second electrical control cabinet 39.

Referring to FIG. 1, the first conveying vehicle 2 and the second conveying vehicle 6 have identical structure. Each of the first conveying vehicle 2 and the second conveying vehicle 6 comprises a fifth isolating valve 14 provided at a first end thereof and a compartment door 7 provided at a second end thereof. When the first conveying vehicle 2 and the second conveying vehicle 6 are respectively coupled with the glove box 1, the sintering furnace 3 or the press machine 5, two connecting flanges of the two isolating valves are connected tightly to form a seal joint. Air between the fifth isolating valve 14 and the first isolating valve 31 or between the fifth isolating valve 14 and the third isolating valve 43 is evacuated by a fourth evacuating pipeline 30 provided in the fifth isolating valve 14 of the conveying vehicle or replaced with inert gas by an inert gas inlet provided in the fifth isolating valve 14 of the conveying vehicle.

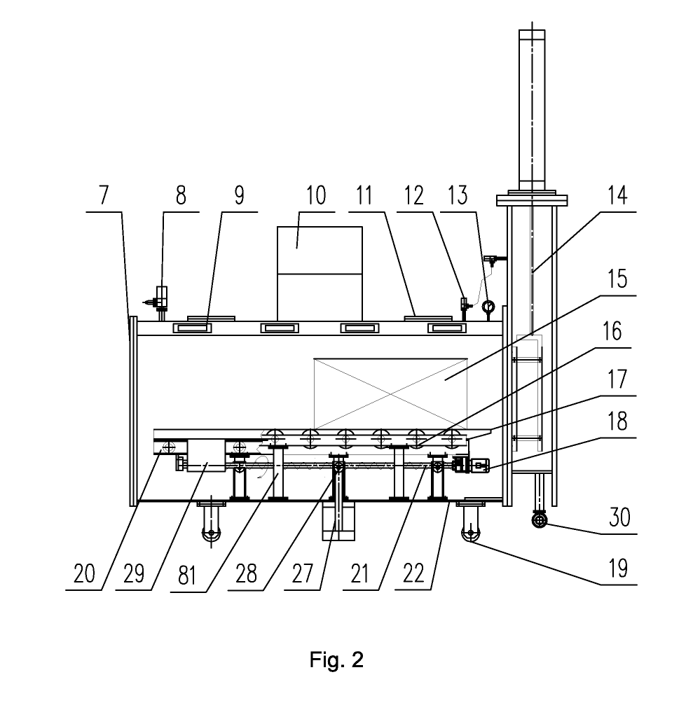

Referring to FIG. 2, a first rolling wheel transmission 16 for conveying material to the glove box 1 and a fork mechanism for conveying the material to the sintering furnace 3 or the press machine 5 are provided in the conveying vehicle. Universal wheels 19 are provided at a bottom of the conveying vehicle. A first evacuating pipeline 12, An inert gas inlet and a first exhaust valve pipeline 8 are provided on the conveying vehicle and connected with the conveying vehicle.

The fork mechanism comprises a fork 17, a guiding track framework of rolling wheels 20, a screw driving component 29, a first speed reducer of motor 18 and a first cylinder 27; wherein the first speed reducer of motor 18 is fixed on the guiding track framework of rolling wheels 20; an output shaft of the first speed reducer of motor 18 is connected with a first end of the screw 21; a second end of the screw 21 is connected with the guiding track framework of rolling wheels 20; the first cylinder 27 supports a rolling wheel axle of the guiding track framework of rolling wheels 20; the screw driving component 29 is fixed on the fork 17; the screw rotates to drive a nut in the screw driving component 29, and the nut further drives a rolling wheel of the fork 17 to roll along the guiding track framework of rolling wheels 20, in such a manner that the fork moves; and the first rolling wheel transmission 16 is installed on a compartment bottom 22 via a supporter 81. The first cylinder 27 is fixed under the compartment. A cylinder rod of the first cylinder 27 extends into the compartment and is connected with a connecting rod of the rolling wheel axle in the guiding track framework of rolling wheels 20 of the fork, and a rolling wheel moves in a track of a first rolling wheel track component 28. The first rolling wheel transmission 16, the second rolling wheel transmission 46 and the third rolling wheel transmission 45 have identical structures. The first rolling wheel transmission 16 is fixed in the conveying vehicle via the supporter 81, and the second rolling wheel transmission 46 and the third rolling wheel transmission 45 are fixed in the glove box 1 via the supporter 81. Each of the rolling wheel transmissions comprises a motor, a plurality of rolling wheel supporters, chain wheels and a chain; wherein the motor drives the chain wheels to rotate, in such a manner that the charging tray 44 on the rolling wheel transmission is driven to move. At work status, the first cylinder 27 drives the rolling wheels of the first rolling wheel track component 28 to move up and down along the track of the first rolling wheel track component 28. The first speed reducer of motor 18 drives the screw driving component 29, and the screw driving component 29 further drives the rolling wheel of the fork 17 moves horizontally along a track of the guiding track framework of rolling wheels 20, in such a manner that the fork 17 is able to move horizontally and vertically.

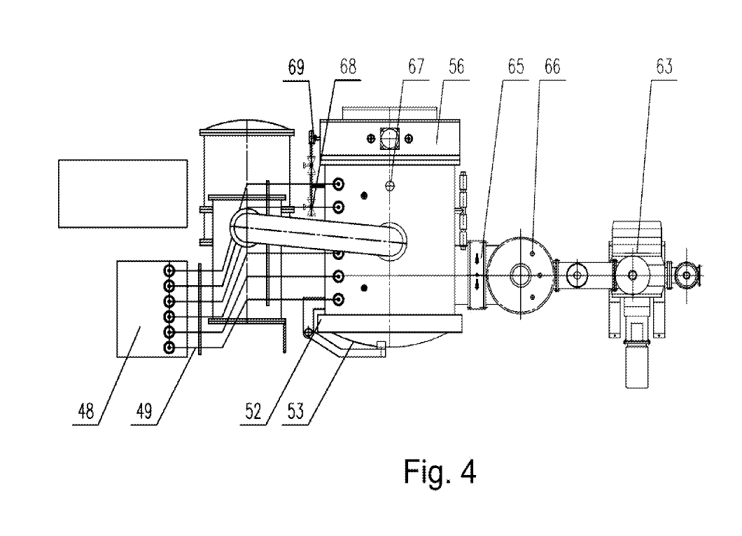

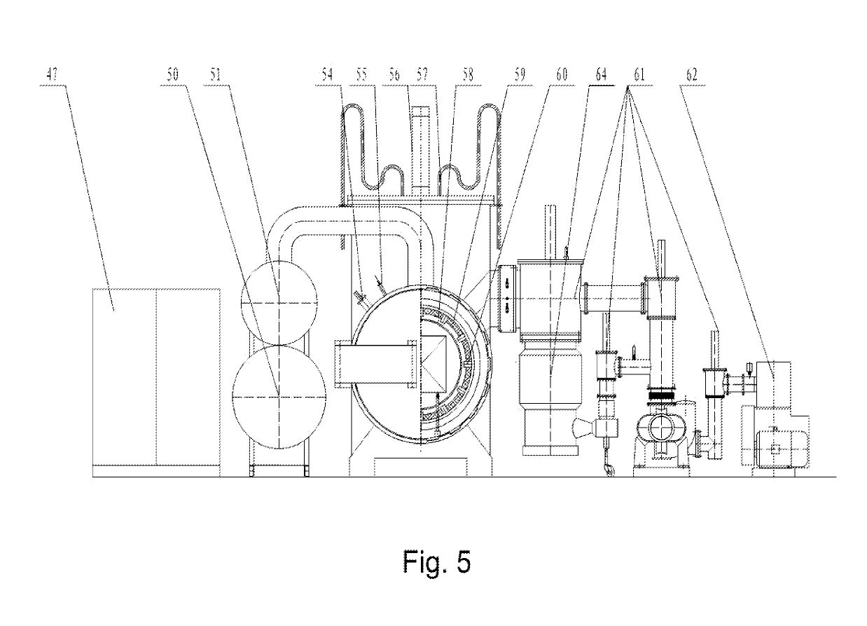

Referring to FIG. 4 and FIG. 5, at least one sintering furnace 3 is provided. If a plurality of sintering furnaces 3 are provided, the sintering furnaces 3 are provided side by side in front of the logistics channel. The sintering furnace 3 comprises a fourth isolating valve 56 provided at a first end thereof, which is also at one side of the logistics channel; and a furnace door 53 provided at a second end thereof, which is locked with a high-pressure furnace ring for locking 52. A furnace chamber of the sintering furnace 3 comprises a heating chamber provided therein, and a thermal insulating layer 59 is provided in the heating chamber. A plurality of groups of heaters 58 and thermocouples 55 are provided in the thermal insulating layer 59. The heaters 58 are connected with a heating power cabinet 48 via an electrode 54 provided on the heating chamber and a copper bar 49 provided outside the heating chamber. A plurality of nozzles 60 which are interconnected go through the thermal insulating layer 59 in a radial direction of the furnace chamber. An outer wall of a furnace shell has a structure of double-layer water-cooling jacket, and water-cooling inlet and outlet pipelines 57 are provided on the outer wall of the furnace shell. An inert gas inlet, a safety valve pipeline 67, an exhaust valve pipeline 68 and a air cooling system are connected with the furnace chamber. The charging tray 44 is placed on a charging shelf of the heating chamber in the sintering furnace by the fork 17 in the first conveying vehicle 2. A balance valve pipeline 69 is provided between the furnace chamber of the sintering furnace 3 and the fourth isolating valve 56 for equalizing pressures.

The air cooling system having an outer circulation system or an inner circulation system comprises a fan 50, a heat exchanger 51, and a plurality of nozzles 60 provided along the furnace chamber. An air duct which is connected with the nozzles 60 has a first end connected with the fan 50, and a second end connected with the heat exchanger 51.

A vacuum system comprises a diffusion pump 64, roots pump 63, rotary piston pump or rotary vane pump 62, and vacuum pipeline, wherein each of the diffusion pump 64, the roots pump 63, and the rotary piston pump or the rotary vane pump 62 comprises a high vacuum flapper valve 61 provided thereon.

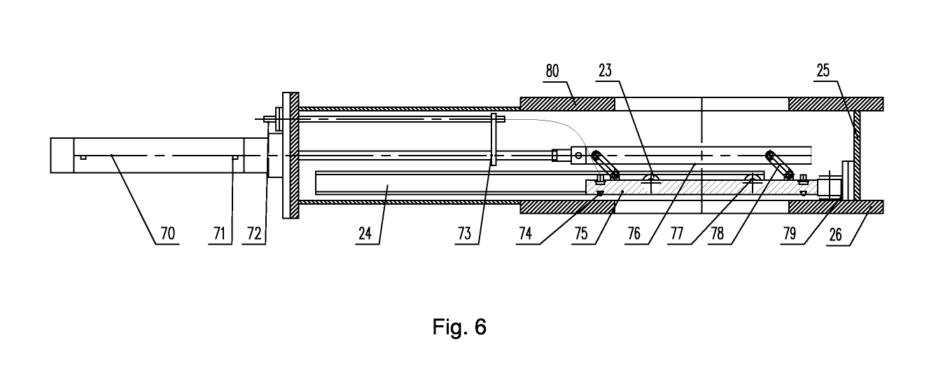

Referring to FIG. 6, all of the isolating valves are sealed in one-way and have structures of gate valve. The isolating valve comprises a valve body, a second cylinder 70, a water-cooling valve board 75 provided therein, a hinge plate 76, connecting rods 78, a second rolling wheel track component 77 and a block 79. The water-cooling valve board 75 is connected with the hinge plate 76 via the connecting rod s 78. A guiding track 24 of the second rolling wheel track component 77 is provided in the valve body. Each of the water-cooling valve board 75 and the hinge plate 76 comprises a rolling wheel 23 which is able to roll in the guiding track 24. The second cylinder 70 is provided outside the valve body. A cylinder rod of the second cylinder 70 extends into the valve body and is connected with the hinge plate 76. The block 79 is provided on a valve bottom 25 in the valve body. The water-cooling valve board 75 comprises a rubber ring 74 provided at one end near a flange at valve port 26. The second cylinder 70 drives the hinge plate 76 to move on the guiding track 24, and then the water-cooling valve board 75 hits the block 79, wherein the connecting rod s 78 pushes water-cooling valve board 75 to move close to the flange at valve port 26 for compressing the rubber ring 74, in such a manner that the isolating valve is sealed. A axle of water inlet and outlet 72 of the water-cooling valve board 75 and the cylinder rod of the second cylinder 70 are linked via a connecting element 73. A thermal insulation board is provided on the water-cooling valve board 75. An upper flange 80 is provided on an upper portion of the valve body. When the isolating valve is in maintenance, the water-cooling valve board 75 is taken out of the valve body through an opening of the upper flange 80.

An operational process of the present invention is as follows.

Power source, gas source, circulating cooling water and gas source of medium are checked. All of main equipments and auxiliary equipments are checked to ensure excellent without damage and in working status. Each of the glove box 1, the sintering furnace 3, the first conveying vehicle 2, the second conveying vehicle 6, and the press machine 5 comprises an independent electrical control cabinet. Decentralized operation mode is adopted, in such a manner that the equipments are in production status, i.e. vacuum system is started and the equipments are interlocking The inert gas valve is opened and adjusted to a certain flow. All of the isolating valve, the furnace door and the compartment door are closed, and the heater is excellent without damage.

Each of the first conveying vehicle 2 and the second conveying vehicle 6 comprises a sealed compartment. At working status, the compartment door 7 and the fifth isolating valve 14 are closed, and the first evacuating pipeline 12 is opened to evacuate the air in the compartment or replace the air in the compartment with inert gas. A first pressure gage 13 is for controlling pressure. First observation windows 9 are symmetrically provided at two sides of the compartment. A first electrical control cabinet 10, a second observation window 11, and the first exhaust valve pipeline 8 are provided on a roof for convenient operation. The universal wheel 19 of the second conveying vehicle 6 moves to drive the second conveying vehicle 6 to respectively coupled with the first isolating valve 31 of the glove box 1 and the press machine 5, wherein the second conveying vehicle 6 is located by a position switch. The universal wheel 19 of the first conveying vehicle 2 moves to drive the first conveying vehicle 2 to respectively coupled with the third isolating valve 43 of the first glove 1 and the sintering furnace 3, wherein the first conveying vehicle 2 is located by the position switch.

(1) Fine powder of rare earth permanent magnetic alloy is weighed, loaded in moulds, and orientedly compacted in the press machine and in inert atmosphere to obtain blanks After the blanks compacted are loaded in charging boxes 15, the charging boxes 15 are piled upon the charging tray 44. After the second conveying vehicle 6 is coupled with the press machine 5, matching flanges of the two isolating valves are locked tightly. After air between the two isolating valves is replaced with inert gas, the two isolating valves connected with each other are opened; wherein the fourth evacuating pipeline 30 is opened to evacuate a holding chamber between the two isolating valves, a vacuum pump is stopped, and then the holding chamber is filled with the inert gas by the inert gas inlet; after the compartment of the second conveying vehicle 6 and the press machine 5 have equal pressures, the two isolating valves are opened. The fork of the second conveying vehicle 6 is started to take the charging tray 44 carrying the charging boxes 15 out of the press machine 5, and the fork transfers the charging tray 44 into the second conveying vehicle 6. Then the two isolating valves are closed, and the matching flanges which have been locked tightly are unlocked. The second conveying vehicle 6 leaves the press machine 5, and then the second conveying vehicle 6 is coupled with the first isolating valve 31 of the first chamber in the glove box 1.

(2) The second conveying vehicle 6 moves to a position of the glove box 1, and is coupled with the first isolating valve 31 of the glove box 1, and then two matching flanges of the two isolating valves are locked tightly. After air between the fifth isolating valve and the first isolating valve is replaced with inert gas, the two isolating valves connected with each other are opened; wherein the fourth evacuating pipeline 30 is opened to evacuate a holding chamber between the fifth isolating valve 14 and the first isolating valve 31, a vacuum pump is stopped, and then the holding chamber is filled with the inert gas by the inert gas inlet; after the compartment of the second conveying vehicle 6 and the first chamber 32 have equal pressures, the fifth isolating valve 14 and the first isolating valve 31 are opened. The first rolling wheel transmission 16 and the second rolling wheel transmission 46 are started to transfer the charging tray 44 carrying the charging boxes 15 into the first chamber 32. The fifth isolating valve 14 and the first isolating valve 31 are closed, the matching flanges of the two isolating valves which has been locked tightly are unlocked, and then the second conveying vehicle 6 leaves. After the first chamber 32 and the second chamber 38 have equal pressures, the second isolating valve 36 of the first glove box 1 is opened. The second rolling wheel transmission 46 and the third rolling wheel transmission 45 are started to transfer the charging tray 44 carrying the charging boxes 15 from the first chamber 32 to the second chamber 38, and then the second isolating valve is closed. The blanks are loaded into graphite charging boxes manually in the second chamber, and the graphite charging boxes are piled upon the charging tray 44.

(3) The first conveying vehicle moves to one end of the first glove box 1 which is close to the second chamber, and is coupled with the third isolating valve 43. Two matching flanges of the two isolating valves are locked tightly. After air between the two isolating valves is replaced with inert gas, the fifth isolating valve and the third isolating valve connected are opened; wherein the fourth evacuating pipeline 30 is opened to evacuate a holding chamber between the fifth isolating valve 14 and the third isolating valve 43, the vacuum pump is stopped, and then the holding chamber is filled with the inert gas by the inert gas inlet; after the compartment of the first conveying vehicle 2 and the second chamber 38 have equal pressures, the fifth isolating valve 14 and the third isolating valve 43 are opened. The first rolling wheel transmission 16 and the third rolling wheel transmission 45 in the second chamber are started to transfer the charging tray 44 carrying the charging boxes 15 from the second chamber to the first conveying vehicle, and then the fifth isolating valve 14 and third isolating valve 43 are closed. The matching flanges of the fifth isolating valve 14 and the third isolating valve 43 which have been locked tightly are unlocked, and then the first conveying vehicle 2 leaves.

(4) The first conveying vehicle 2 moves a position of the sintering furnace 3 and is coupled with the fourth isolating valve 56. Matching flanges of the fifth isolating valve 14 and the fourth isolating valve 56 are locked tightly. After air between the fifth isolating valve 14 and the fourth isolating valve 56 is replaced with inert gas, a balance valve is opened to equalize pressures in the sintering furnace and the first conveying vehicle, and then the fifth isolating valve 14 and the fourth isolating valve 56 connected with each other are opened, wherein the fourth evacuating pipeline 30 is opened to evacuate a holding chamber between the fifth isolating valve 14 and the fourth isolating valve 56, the vacuum pump is stopped, and then the holding chamber is filled with the inert gas by the inert gas inlet; after the first conveying vehicle 2 and the sintering furnace 3 have equal pressures, the fifth isolating valve 14 and the fourth isolating valve 56 are opened. The first speed reducer of motor 18 is started, and the screw driving component 29 drives the fork 17 to extend into the sintering furnace 3. The first cylinder 27 drives the fork 17 to moves downward along the first rolling wheel track component 28. The charging tray 44 is placed on the charging shelf of the sintering furnace 3, and the fork 17 goes back to the first conveying vehicle 2. The fourth isolating valve 56 and the fifth isolating valve 14 are closed, the matching flanges thereof which have been locked tightly are unlocked, and then the first conveying vehicle 2 leaves.

(5) After the sintering furnace 3 is evacuated to a vacuum degree more than 50 Pa, or the sintering furnace 3 is filled with protective gas, the blanks are processed with heating and heat preservation according to a preset process curve. The blanks are sintered at a highest temperature of 1200° C. The sintering furnace 3 is filled with inert gas, such as nitrogen or argon, to a pressure of 0.01˜0.03 MPa. The fan 50 is started to cool the charging boxes 15 and the blanks of the rare earth permanent magnetic alloy therein, wherein cooling gas blows to the charging boxes 15 via the nozzle 60 of the air duct; the gas which has been heated is cooled circularly by the heat exchanger 51 having high efficiency under driving of the fan 50. The second electrical control cabinet 39 electrically controls the sintering furnace 3. When the temperature is lower than 80° C., the fan is stopped after at least 5 minutes. The furnace chamber is filled with gas by the exhaust valve pipeline 68. After the pressure in the furnace chamber is equal to atmosphere, the fourth isolating valve of the sintering furnace 3 is opened. A fork of the discharging vehicle 4 takes the charging tray 44 out of the sintering furnace 3, the fourth isolating valve is closed, and then the discharging vehicle 4 leaves.

During productive process, an external control system is able to monitor status of equipments continuously, and the equipments run automatically according to a preset program. Whole operation is finished on a human-computer interface of the computer.

A screen of the external control system provides following information, i.e. working status of the vacuum pumps, vacuum valves and the vacuum pipelines; driving the conveying vehicles and displaying transferring and operating status of the conveying vehicles; driving the isolating valves and displaying operating status of the isolating valves; displaying the pressures of the glove box 1, the sintering furnace 3, the first conveying vehicle 2, the second conveying vehicle 6 and the fifth isolating valve 14, and the temperature of the sintering furnace 3; operating status of the inert gas and the safety valve; actual pressures of the cooling water, dynamic gas pressure and alarm management; displaying all related technological parameters (set values and actual values); inputting parameters; and displaying and storing historical process parameters/data. All of the main elements in the equipments are able to be operated via the screen.

Products respectively produced according to techniques in the present invention and conventional techniques have different performances which are compared as follows.

Comparison example: Materials are prepared according to weight proportion as: 18% Nd, 8.5% Pr, 3% Dy, 1.02% B, 0.3% Al and balance being Fe. After smelting, hydrogen pulverization, jet mill, and magnetic compaction, compacts are sintered in a one-chamber sintering furnace with a protective glove box which has been evacuated. A temperature is increased to 430° C., and then the compacts are processed with vacuum heat preservation for 3 hours, wherein vacuum degree is higher than 1 Pa. After the heat preservation, the temperature is increased to 850° C., and then the temperature is kept for 2 hours. Afterwards, when the temperature is increased to 1080° C., the compacts are processed with vacuum sintering, and then the temperature is kept for 2 hours, wherein the vacuum degree is E-2 Pa. Finally, the compacts are processed with aging in 900° C. for two hours and aging in 500° C. for four hours.

### EXAMPLE 1

Materials are prepared according to the weight proportion in the comparison example, and then compacts are sintered by the sintering method in the present invention. Before the temperature is increased, the sintering furnace is evacuated. When vacuum degree is more than 1 Pa, the temperature is increased to 400° C. and then kept for 3 hours. The temperature in a heating furnace is repeatedly increased and then kept for some time in range of 400° C.˜850° C. Afterwards, the temperature is increased to 850° C. and then kept for 2 hours, wherein the vacuum degree is 3 E-2 Pa. The temperature continues to be increased to 1080° C. and then kept for 2 hours, wherein the vacuum degree is E-2 Pa. Finally, the compacts are processed with aging by the method described in the comparison example.

### EXAMPLE 2

Materials are prepared according to the weight proportion in the comparison example, and then compacts are sintered by the sintering method in the present invention. Before the temperature is increased, the sintering furnace is evacuated. When vacuum degree is more than 1 Pa, the temperature is increased to 450° C. and then kept for 3 hours. The temperature in the heating furnace is repeatedly increased and then kept for some time in range of 450° C.˜850° C. Afterwards, the temperature is increased to 850° C. and then kept for 2 hours, wherein the vacuum degree is 3 E-2 Pa. The temperature continues to be increased to 1080° C. and then kept for 2 hours, wherein the vacuum degree is E-2 Pa. Finally, the compacts are processed with aging by the method described in the comparison example.

### EXAMPLE 3

Materials are prepared according to the weight proportion in the comparison example, and then compacts are sintered by the sintering method in the present invention. Before the temperature is increased, the sintering furnace is evacuated. When vacuum degree is more than 1 Pa, the temperature is increased to 400° C. and then kept for 3 hours. The temperature in the heating furnace is repeatedly increased and then kept for some time in range of 400° C.˜900° C. Afterwards, the temperature is increased to 900° C. and then kept for 2 hours, wherein the vacuum degree is 3 E-2 Pa. The temperature continues to be increased to 1080° C. and then kept for 2 hours, wherein the vacuum degree is E-2 Pa. Finally, the compacts are processed with aging by the method described in the comparison example.

### EXAMPLE 4

Materials are prepared according to the weight proportion in the comparison example, and then compacts are sintered by the sintering method in the present invention. Before the temperature is increased, the sintering furnace is evacuated. When vacuum degree is more than 1 Pa, the temperature is increased to 400° C. and then kept for 3 hours. The temperature in the heating furnace is repeatedly increased and then kept for some time in range of 400° C.˜900° C. Afterwards, the temperature is increased to 900° C. and then kept for 2 hours, wherein the vacuum degree is 3 E-2 Pa. The temperature continues to be increased to 1070° C. and then kept for 3 hours, wherein the vacuum degree is E-2 Pa. Finally, the compacts are processed with aging by the method described in the comparison example.

### EXAMPLE 5

Materials are prepared according to the weight proportion in the comparison example, and then compacts are sintered by the sintering method in the present invention. Before the temperature is increased, the sintering furnace is evacuated. When vacuum degree is more than 1 Pa, the temperature is increased to 500° C. and then kept for 3 hours. The temperature in the heating furnace is repeatedly increased and then kept for some time in range of 500° C.˜900° C. Afterwards, the temperature is increased to 900° C. and then kept for 2 hours, wherein the vacuum degree is 3 E-2 Pa. The temperature continues to be increased to 1070° C. and then kept for 3 hours, wherein the vacuum degree is E-2 Pa. Finally, the compacts are processed with aging by the method described in the comparison example.

| | Item | | |
|---|---|---|---|
| | Retentivity | Coercivity | Magnetic energy |
| | Br | Hcj | product (BH) max |
| Number | (KGs) | (KOe) | (MGOe) |
| Comparison | 13.1 | 24.5 | 43.5 |
| example | | | |
| Example 1 | 13.2 | 25.5 | 43.9 |
| Example 2 | 13.3 | 25.3 | 44.4 |
| Example 3 | 13.2 | 25.4 | 43.9 |
| Example 4 | 13.4 | 26.7 | 45.9 |
| Example 5 | 13.4 | 26.5 | 45.7 |

From the above examples, in a parallel-type flexible production method of the present invention, the sealed glove box of the one-chamber sintering furnace is removed. Instead, a glove box is provided to operate with a plurality of one-chamber sintering furnaces with isolating valves. The conveying vehicles are coupled with the sintering furnace and the press machine in the protective atmosphere, in such a manner that non-oxidation connection from compaction to sintering is realized. Compared with the conventional method adopting the sintering furnace with the glove box, the method in the present invention significantly improves magnet performance and automaticity of production.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for flexibly sintering rare earth permanent magnetic alloy, comprising:
(1) weighing fine powder of rare earth permanent magnetic alloy, loading the fine powder in moulds, and orientedly compacting the fine powder in a press machine and in inert atmosphere to obtain blanks; wherein after the blanks compacted are loaded in charging boxes, the charging boxes are piled upon a charging tray; after a second conveying vehicle is coupled with the press machine, matching flanges of two isolating valves are locked tightly; after air between the two isolating valves is replaced with inert gas, the two isolating valves are opened; after a fork of the second conveying vehicle transfers the charging tray in the press machine into the second conveying vehicle, the two isolating valves are closed; and the second conveying vehicle leaves and then is coupled with a first isolating valve of a first chamber in a glove box;
(2) after air between the second conveying vehicle and the first isolating valve of the glove box is replaced with inert gas, opening the two isolating valves connected with each other; wherein after a first rolling wheel transmission in the second conveying vehicle transfers the charging tray into the first chamber of the glove box, the two isolating valves are closed, and the second conveying vehicle leaves; after a second isolating valve of the glove box is opened, material in the first chamber is transferred to a second chamber by rolling wheel transmissions, and then the second isolating valve is closed; and the blanks are loaded into graphite charging boxes manually in the second chamber, and the graphite charging boxes are piled upon the charging tray;
(3) after a first conveying vehicle is coupled with a third isolating valve at an end of the second chamber, locking two matching flanges of the two isolating valves tightly; wherein after air between the two isolating valves is replaced with inert gas, the two isolating valves connected with each other are opened; rolling wheel transmissions in the second chamber and the first conveying vehicle are started to transfer the charging tray in the second chamber to the first conveying vehicle; the two isolating valves are closed; and then the first conveying vehicle leaves;
(4) after the first conveying vehicle is coupled with an isolating valve of a sintering furnace, locking matching flanges tightly; wherein after air between the two isolating valves is replaced with inert gas, a balance valve is opened to equalize pressures in the sintering furnace and the first conveying vehicle; after the pressures are equal, the two isolating valves connected with each other are opened; a fork mechanism in the first conveying vehicle which is horizontally driven by a screw and vertically driven by a cylinder is started to transfer the charging tray into the sintering furnace; the two isolating valves are closed; and then the first conveying vehicle leaves; and
(5) after the sintering furnace is evacuated to a vacuum degree more than 50 Pa, or the sintering furnace is filled with protective gas, processing the blanks with heating and heat preservation according to a preset process curve; wherein the blanks are sintered at a highest temperature of 1200° C.; the sintering furnace is filled with nitrogen or argon to a pressure of 0.01˜0.03 MPa; a fan is started to cool the charging boxes and the blanks of the rare earth permanent magnetic alloy therein, until the temperature is lower than 80° C., and then the fan is stopped after at least 5 minutes; after the pressure in a furnace chamber is equal to atmosphere, the fourth isolating valve of the sintering furnace is opened; a fork of a discharging vehicle takes out the charging tray, the fourth isolating valve is closed, and then the discharging vehicle leaves.

2. A sintering equipment for said method, as recited in claim 1, comprising: a glove box, two conveying vehicles with sealed compartments, a press machine, a sintering furnace and a discharging vehicle; wherein two logistics channels are respectively provided at two ends of said glove box; said press machine and said sintering furnace are aligned at one side of said two logistics channels; said two conveying vehicles are able to move respectively in said two logistics channels; each of said two conveying vehicles, said sintering furnace and said press machine comprises an isolating valve provided at a corresponding end thereof; said glove box comprises two isolating valve respectively provided at said two ends thereof; and said two conveying vehicles are respectively coupled with said glove box, said press machine and said sintering furnace via said isolating valves.

3. The sintering equipment, as recited in claim 2, wherein said glove box is a sealed box comprising two sealed chambers which are vacuum or filled with protective atmosphere; said two sealed chambers in said glove box are a first chamber and a second chamber; a second isolating valve is provided between said two sealed chambers; a first isolating valve and a third isolating valve are provided at two ends of said two sealed chamber; each of said chambers comprises an evacuating pipeline, an inert gas inlet, an exhaust valve pipeline, a pressure gage and a vacuum gauge; a balance valve pipeline is provided between said two chambers for equalizing pressures of said two sealed chambers; and a second rolling wheel transmission and a third rolling wheel transmission for a charging tray to place on are respectively provided in said two chambers, wherein said second chamber comprises a glove flange component.

4. The sintering equipment, as recited in claim 2, wherein said conveying vehicle comprises an isolating valve provided at a first end thereof, and a compartment door provided at a second end thereof; and when said conveying vehicles are respectively coupled with said glove box, said sintering furnace or said press machine, two connecting flanges of said two isolating valves are connected tightly to form a seal joint.

5. The sintering equipment, as recited in claim 2, wherein said first rolling wheel transmission for transferring material to said glove box and a fork mechanism for transferring said material to said sintering furnace are provided in said conveying vehicle; universal wheels are provided at a bottom of said conveying vehicle; and a first evacuating pipeline, an inert gas inlet and a first exhaust valve pipeline are provided on said conveying vehicle and connected with said conveying vehicle.

6. The sintering equipment, as recited in claim 5, wherein said fork mechanism comprises a fork, a guiding track framework of rolling wheels, a screw driving component, a first speed reducer of motor and a first cylinder; an output shaft of said first speed reducer of motor is connected with a first end of a screw of said screw driving component; a second end of said screw driving component is connected with said guiding track framework of rolling wheels which is supported by said first cylinder; and said first rolling wheel transmission is installed on a compartment bottom via a supporter.

7. The sintering equipment, as recited in claim 6, wherein said first cylinder is fixed under said compartment; a cylinder rod of said first cylinder extends into said compartment and is connected with a connecting rod of a rolling wheel axle in said guiding track framework of rolling wheels; and a rolling wheel moves in a track of a first rolling wheel track component.

8. The sintering equipment, as recited in claim 2, wherein at least one sintering furnace is provided; said sintering furnace comprises: a fourth isolating valve provided at a first end thereof, which is also at one side of said logistics channel, and a furnace door provided at a second end thereof, which is locked with a high-pressure furnace ring for locking; a furnace chamber of said sintering furnace comprises a heating chamber provided therein, and a thermal insulating layer is provided in said heating chamber; a plurality of groups of heaters and thermocouples are provided in said thermal insulating layer; said heaters are connected with a heating power cabinet via a electrode provided on said heating chamber and a copper bar provided outside said heating chamber; a plurality of nozzles which are interconnected go through said thermal insulating layer in a radial direction of said furnace chamber; an outer wall of a furnace shell has a structure of double-layer water-cooling jacket, and water-cooling inlet and outlet pipelines are provided on said outer wall of said furnace shell; an inert gas inlet, a safety valve pipeline, an exhaust valve pipeline and a air cooling system are connected with said furnace chamber; and said charging tray is placed on a charging shelf of said heating chamber in said sintering furnace by said fork in said first conveying vehicle.

9. The sintering equipment, as recited in claim 8, wherein a balance valve pipeline is provided between said furnace chamber of said sintering furnace and said fourth isolating valve for equalizing pressures.

10. The sintering equipment, as recited in claim 8, wherein said air cooling system having an outer circulation system or an inner circulation system comprises a fan, a heat exchanger, and a plurality of nozzles provided along said furnace chamber; an air duct which is connected with said nozzles has a first end connected with said fan, and a second end connected with said heat exchanger.

11. The sintering equipment, as recited in claim 8, wherein a plurality of sintering furnaces are provided, said sintering furnaces are provided side by side in front of said logistics channel.
